(19) United States
(12) Patent Application Publication
(10) Pub. No.: US 2017/0117718 A1
(43) Pub. Date: Apr. 27, 2017

(54) BATTERY MANAGEMENT SYSTEM AND METHOD

(71) Applicant: Industrial Technology Research Institute, Hsinchu (TW)

(72) Inventors: Bo-Ting YEH, Taipei City (TW); Kai-Cheung JUANG, Hsinchu City (TW)

(21) Appl. No.: 14/982,755

(22) Filed: Dec. 29, 2015

(30) Foreign Application Priority Data
Oct. 22, 2015 (TW) 104134630

(51) Int. Cl. H02J 7/00

(52) U.S. Cl. CPC H02J 7/007; H02J 7/0031; H02J 2007/0039

(57) ABSTRACT

A battery management system and method are provided. The battery management system includes a plurality of battery devices, wherein each of the battery devices is connected in parallel. Each of the battery devices includes one or a plurality of battery cells which is configured to provide power, a switch circuit, and a controller which is configured to detect a reverse current. When the controller detects the reverse current, the controller will disable the switch circuit and enable a judgment mechanism to determine whether to re-enable the switch circuit.

### CROSS REFERENCE TO RELATED APPLICATIONS

This Application claims priority of Taiwan Patent Application No. 104134630, filed on Oct. 22, 2015, the entirety of which is incorporated by reference herein.

### TECHNICAL FIELD

The disclosure generally relates to a battery management technology, and more particularly, to a battery management technology for enabling a judgment mechanism for a plurality of battery devices which are connected in parallel to achieve a balanced state.

### BACKGROUND

Multiple battery devices may be connected in series or parallel, and no matter which connection method is selected for the multiple battery devices, a battery balancing technology is needed. The series connection method is widely applied in products, and it is a well-developed technology. In a parallel connection, the operation between the battery devices is like a competition relationship. Therefore, when the battery devices in parallel do not achieve a balance, the battery device with the lower power may be not able to provide power to the load, or may be charged by a battery device with power. As a result, problems with the reverse current or a single battery device of the battery devices providing power to load may occur. However, although the parallel connection may suffer from more complex problems than a series connection, compared with a series connection, a parallel connection has the advantages of providing a power reserve and providing a higher current.

In current parallel-connection applications, a battery management system needs a central control system to collect all battery information of all battery devices to control the battery devices to achieve a battery balance. Although the central control system can resolve the problems with the reverse current or a single battery device of the battery devices providing power to the load, the configuration of the central control system may add to the cost and power consumption, and the computational complexity may increase because of the need to compute all collected battery information.

Therefore, how battery devices connected in parallel can achieve a battery balance without needing a central control system to collect all battery information of all battery devices to control the battery devices is a subject worthy of discussion.

### SUMMARY

A battery management system and a method for a plurality of battery devices which are connected in parallel to achieve a balanced state by a judgment mechanism are provided to overcome the aforementioned problems.

An embodiment of the disclosure provides a battery management system. The management system comprises a plurality of battery devices, wherein each of the battery devices is connected in parallel. Each of the battery devices comprises one or a plurality of battery units, a switch circuit, and a controller. The battery units are configured to provide power. The controller is configured to detect a reverse current. When the controller detects the reverse current, the controller disables the switch circuit and enables a judgment mechanism to determine whether to re-enable the switch circuit.

In the embodiment of the disclosure, the judgment mechanism comprises a step of detecting whether a terminal voltage difference value is greater than a first threshold, wherein when the terminal voltage difference value is greater than the first threshold, the controller re-enables the switch circuit. In the embodiment of the disclosure, the judgment mechanism may also comprise the step of detecting whether the delay time is longer than or equal to a second threshold, wherein when the delay time is longer than or equal to the second threshold, the controller re-enables the switch circuit.

In the embodiment of the disclosure, the controller is further configured to detect an over current, and limit the current value of the battery device corresponding to the controller to a default value when the controller detects the over current.

An embodiment of the disclosure provides a battery management method, applied to a battery device which is connected in parallel. The battery management method comprises the steps of detecting whether a reverse current is generated; disabling the switch circuit of the battery device when a reverse current is detected; and enabling a judgment mechanism to determine whether to re-enable the switch circuit.

In the embodiment of the disclosure, the judgment mechanism comprises the steps of detecting whether the terminal voltage difference value is greater than a first threshold; and re-enabling the switch circuit when the terminal voltage difference value is greater than the first threshold. In the embodiment of the disclosure, the judgment mechanism may also comprise the step of detecting whether the delay time is longer than or equal to a second threshold; and re-enabling the switch circuit when the delay time is longer than or equal to the second threshold.

In the embodiment of the disclosure, the battery management method further comprises the steps of detecting whether an over current is generated; and limiting the current value of the battery device to the default value when an over current is detected.

Other aspects and features of the disclosure will become apparent to those with ordinary skill in the art upon review of the following descriptions of specific embodiments of user equipment, systems and methods.

### BRIEF DESCRIPTION OF THE DRAWINGS

The disclosure will become more fully understood by referring to the following detailed description with reference to the accompanying drawings, wherein:

FIG. 1A is a block diagram illustrating the battery management system 100 in a discharged state according to an embodiment of the disclosure;

FIG. 1B is a block diagram illustrating the battery management system 100 in a charged state according to an embodiment of the disclosure;

FIG. 2A is a flowchart 200A of a battery management method according to an embodiment of the disclosure;

FIG. 2B is a flowchart 200B of a battery management method according to another embodiment of the disclosure;

FIG. 3A is a flowchart 300A of a battery management method according to an embodiment of the disclosure;

FIG. 3B is a flowchart 300B of a battery management method according to another embodiment of the disclosure;

FIG. 4A is a flowchart 400A of a battery management method according to an embodiment of the disclosure;

FIG. 4B is a flowchart 400B of a battery management method according to another embodiment of the disclosure.

### DESCRIPTION OF THE EMBODIMENTS

This description is made for the purpose of illustrating the general principles of the disclosure and should not be taken in a limiting sense. The scope of the disclosure is best determined by reference to the appended claims.

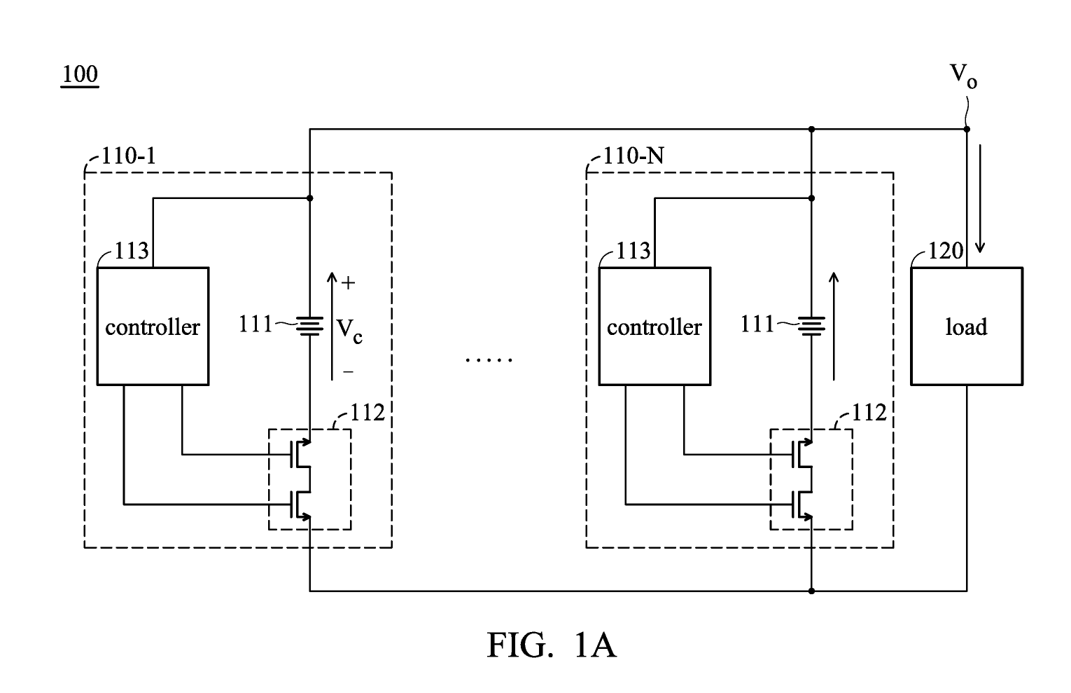

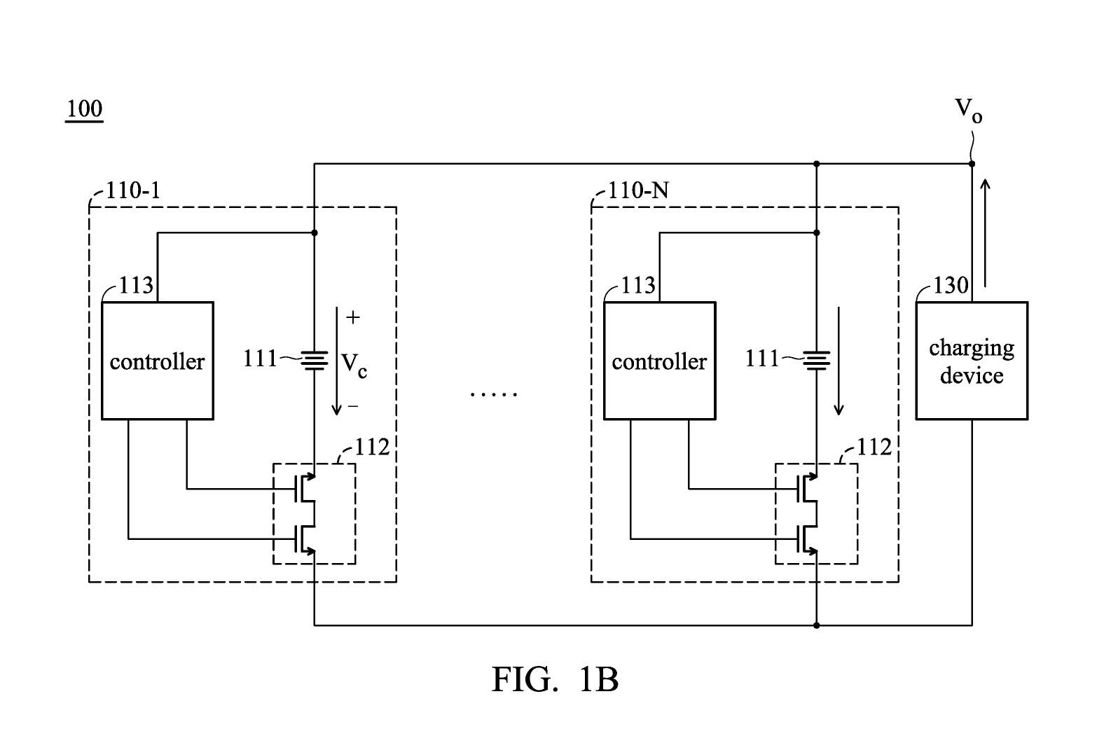

FIG. 1A is a block diagram illustrating the battery management system 100 in a discharged state according to an embodiment of the disclosure. As shown in FIG. 1A, the battery management system 100 comprises a plurality of battery devices 110-1˜110-N, wherein the battery devices 110-1˜110-N are connected in parallel. Each of the battery devices 110-1˜110-N comprises one or a plurality of battery units 111, a switch circuit 112, and a controller 113. When the battery management system 100 is in the discharged state, the battery management system 100 may connect with a load 120 to provide power to the load 120. It should be noted that the block diagram shown in FIG. 1A is for the purpose of simplicity and clarity. However, the disclosure should not be limited to what is shown in FIG. 1A. Each of the battery devices 110-1˜110-N can also comprise other elements. In addition, it should be noted that, in order to conveniently illustrate the embodiments the disclosure, all of the battery units, the switch circuits, and the controllers for each of the battery devices 110-1˜110-N are indicated as the battery units 111, the switch circuit 112, and the controller 113. However, it does not mean that they are the same elements in the battery management system 100.

FIG. 1B is a block diagram illustrating the battery management system 100 in a charged state according to an embodiment of the disclosure. As shown in FIG. 1B, when the battery management system 100 is in the charged state, the battery management system 100 may connect with a charging device 130 to charge the battery management system 100. It should be noted that the block diagram shown in FIG. 1B is for the purpose of simplicity and clarity. However, the disclosure should not be limited to what is shown in FIG. 1B. Each of the battery devices 110-1˜110-N can also comprise other elements.

In an embodiment of the disclosure, the battery units 111 are configured to provide power. The switch circuit 112 is composed by two Metal-Oxide-Semiconductor Field-Effect Transistor (MOSFET), and is configured to open or close the battery devices 110-1˜110-N. The controller 113 is configured to enable or disable the switch circuit 112 to determine whether to open or close the battery devices 110-1˜110-N. In some embodiments of the disclosure, the controller 113 may be an electrical device, a processor, or a chip.

In the battery devices 110-1˜110-N which are connected in parallel, because some battery devices are new and some battery devices are old, each of the battery devices 110-1˜110-N may have different respective electric quantities. Therefore, when the battery devices 110-1˜110-N do not achieve a balanced state, a battery device which has a higher electric quantity may charge a battery device which has a lower electric quantity, and as a result, a reverse current may be generated.

In an embodiment of the disclosure, the controller 113 is configured to detect a reverse current, i.e. the controller 113 may determine whether the flow direction of the current conforms to the present state (e.g. a discharged state or a charged state). For example, if the battery management system 100 is in a charged state, when a current which has a discharge direction (e.g. the direction from the battery units 111 to the load 120) is generated, the controller 113 will determine that a reverse current has occurred, or if the battery management system 100 is in a discharged state, when a current which has charge direction (e.g. the direction from the charging device 130 to the battery units 111) is generated, the controller 113 will determine that a reverse current has occurred. When the battery devices 110-1˜110-N have been enabled, the controller 113 of each battery devices 110-1˜110-N may detect whether a reverse current is generated. When the controller 113 detects a reverse current, the controller 113 will disable the switch circuit 112 to close the battery device corresponding to this controller 113. Then, the controller 113 will perform a judgment mechanism to determine whether to re-enable the switch circuit 112. For example, when the controller 113 of the battery device 110-1 detects a reverse current, the controller 113 will disable the switch circuit 112 to close the battery device 110-1.

In an embodiment of the disclosure, the judgment mechanism indicates that the controller may detect whether a terminal voltage difference value is greater than a first threshold. When the terminal voltage difference value is greater than the first threshold, the controller 113 will re-enable the switch circuit 112 to enable the battery device corresponding to this controller 113. When the terminal voltage difference value is lower than or equal to the first threshold, the controller 113 will re-detect whether the terminal voltage difference value is greater than the first threshold until the battery devices 110-1˜110-N achieve a balanced state. In an embodiment of the disclosure, the first threshold may be a default value which is lower than a maximum voltage value of the battery devices 110-1˜110-N.

In an embodiment of the disclosure, when the battery management system 100 is in the discharged state, the terminal voltage difference value is regarded as a voltage difference value between the terminal voltages of the battery units 111 and the load 120. As shown in FIG. 1A, in the embodiment of the disclosure, the terminal voltage difference value is regarded as a voltage difference value between the terminal voltage V_{c} of the battery units 111 and the terminal voltage Vₒ of the load 120. In another embodiment of the disclosure, when the battery management system 100 is in a discharged state, the terminal voltage difference value is regarded as the voltage difference value between the first voltage value and the second voltage value, wherein the first voltage value and the second voltage value are meant to be the voltage values of the load 120 at different points in time. As shown in FIG. 1B, in the embodiment of the disclosure, the terminal voltage difference value is regarded as the voltage difference value between the first voltage value corresponding to the terminal voltage Vₒ of the load 120 at the first time point and the second voltage value corresponding to the terminal voltage Vₒ of the load 120 at the second time point.

In an embodiment of the disclosure, when the battery management system 100 is in the charged state, the terminal voltage difference value is regarded as the voltage difference value between the terminal voltages of the battery units 111 and the charging device 130. As shown in FIG. 1B, in the embodiment of the disclosure, the terminal voltage difference value is regarded as a voltage difference value between the terminal voltage V_{c} of the battery units 111 and the terminal voltage Vₒ of the charging device 130. In another embodiment of the disclosure, when the battery management system 100 is in the discharged state, the terminal voltage difference value is regarded as a voltage difference value between a first voltage value and a second voltage value, wherein the first voltage value and the second voltage value are the voltage values of the charging device 130 at different time points. As shown in FIG. 1B, in the embodiment of the disclosure, the terminal voltage difference value is regarded as the voltage difference value between the first voltage value corresponding to the terminal voltage Vₒ of the charging device 130 at the first time point and the second voltage value corresponding to the terminal voltage Vₒ of the charging device 130 at the second time point.

In addition, in another embodiment of the disclosure, the judgment mechanism indicates that the controller 113 may detect whether the delay time is longer than or equal to a second threshold, i.e. the controller 113 may detect whether the close time of the battery device is longer than or equal to the second threshold. When the delay time is longer than or equal to the second threshold, the controller 113 will re-enable the switch circuit 112 to enable the battery device corresponding to this controller 113. When the terminal voltage difference value is lower than the second threshold, the controller 113 will re-detect whether the delay time is longer than or equal to the second threshold until the battery devices 110-1˜110-N achieve a balanced state. In an embodiment of the disclosure, the second threshold is a default time value. In an embodiment of the disclosure, the second threshold may be set to different values for each of the battery devices 110-1˜110-N.

In another embodiment of the disclosure, the judgment mechanism may comprise the processes of detecting the terminal voltage difference value or delay time at the same time. For example, when the controller 113 detects that the terminal voltage difference value is lower than or equal to the first threshold, the controller 113 will sequentially detect whether the delay time is longer than or equal to the second threshold. When the delay time is longer than or equal to the second threshold, the controller 113 will re-enable the switch circuit 112 to enable the battery device corresponding to this controller 113. When the terminal voltage difference value is lower than the second threshold, the controller 113 will continue to detect whether the terminal voltage difference value is greater than the first threshold until the battery devices 110-1˜110-N achieve a balanced state.

In an embodiment of the disclosure, the controller 113 can also detect an over current, i.e. the controller 113 may detect whether the present current is greater than the maximum support current value of the battery device. For example, when the battery management system 100 is in a discharged state, if the load 120 generates a large current, the battery device which has a higher electric quantity may need to provide a current which is greater than the maximum support current value of the battery device to the load 120, and as a result, an over current will be generated. Otherwise, when the battery management system 100 is in a charged state, if the charging device 130 is in the Constant Voltage (CV) mode, the battery device which has a lower electric quantity may need to accept a current which is greater than the maximum support current value of the battery device from the charging device 130, and as a result, an over current will be generated.

Therefore, if the present current is greater than the maximum support current value of the battery device, the controller 113 will detect that an over current is generated. When the controller 113 detects the over current, the controller 113 will limit the current value of the battery device which generates the over current to the default value (e.g. the maximum current value which the battery device can support). Specifically, when the battery management system 100 is in a discharged state, the controller 113 will limit the output current value of the battery device which generates the over current to the default value (e.g. the maximum current value which the battery device can support). When the battery management system 100 is in a charged state, the controller 113 will limit the input current value of the battery device which generates an over current to the default value (e.g. the maximum current value which the battery device can support). For example, if the maximum current value which the battery device 110-1 can support is 30 A (e.g. the default value), when the controller 113 of the battery device 110-1 detect that the over current (e.g. 40 A) which is greater than the maximum current value which the battery device 110-1 can support is being generated, the controller 113 will limit the current value of the battery device to 110-1 to 30 A.

It should be noted that the order of detecting the reverse current and the over current for the controller 113 can be adjusted. That is to say, the controller 113 can detect whether the reverse current is generated first, or it can detect whether the over current is generated first.

In an embodiment of the disclosure, each of the battery devices 110-1˜110-N further comprises a protection device (not shown in figure) to protect the battery management system 100. When an abnormal event is detected in one of the battery devices 110-1˜110-N is, e.g. the temperature of the battery device has been higher than a third threshold, the voltage of the battery device has been higher than a fourth threshold, the voltage of the battery device has been lower than a fifth threshold, or an over current is being generated over a default time, the protection device of the battery device will disable the battery device and not re-enable the battery device (i.e. the battery device will not perform the judgment mechanism of the disclosure).

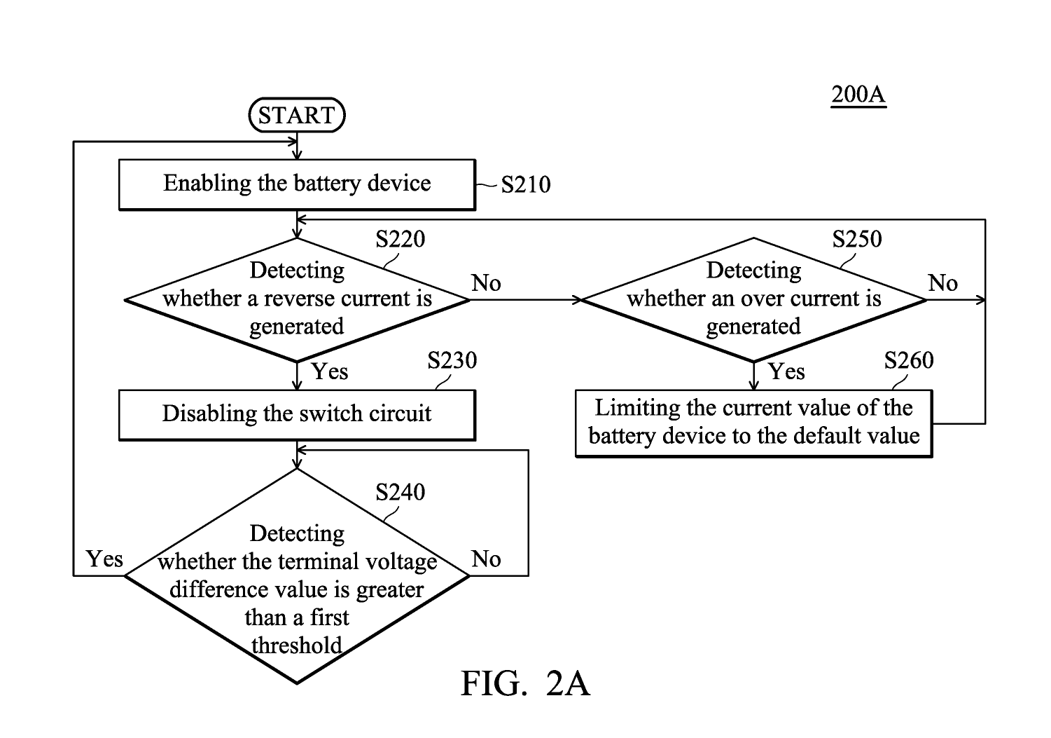

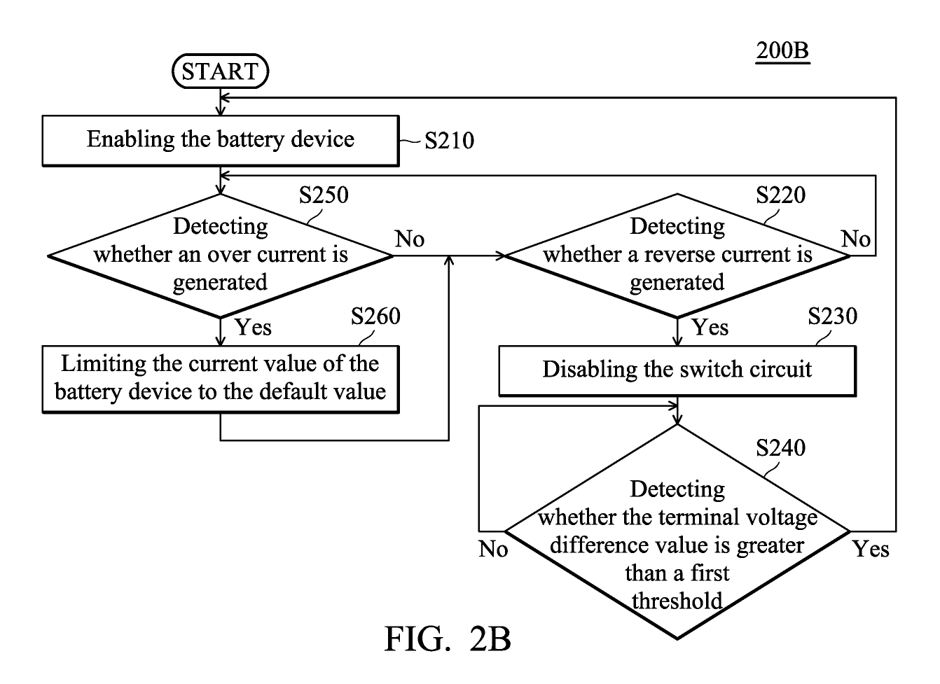

FIG. 2A is a flowchart 200A of a battery management method according to an embodiment of the disclosure. The battery management method is applied to each of the battery devices 110-1˜110-N. As shown in FIG. 2A, in step S210, the battery device is enabled. In step S220, the controller 113 detects whether a reverse current is generated. If the controller 113 detects a reverse current, step S230 will be performed. In step S230, the controller 113 disables the switch circuit 112. Then, in step S240, the controller 113 will enable a judgment mechanism to detect whether the terminal voltage difference value is greater than a first threshold. When the terminal voltage difference value is greater than the first threshold, the method returns to step S210, i.e. the controller 113 will re-enable the switch circuit 112 to enable the battery device. When the terminal voltage difference value is lower than or equal to the first threshold, the method returns to step S240.

If the controller 113 does not detect the reverse current, step S250 will be performed. In step S250, the controller 113 will detect whether an over current is generated. When the controller 113 detects the over current, step S260 is performed. In step S260, the controller 113 will limit the current value of the battery device to the default value. When the controller 113 does not detect the over current, the method returns to step S220.

FIG. 2B is a flowchart 200B of a battery management method according to another embodiment of the disclosure. The battery management method is applied to each of the battery devices 110-1˜110-N. As shown in FIG. 2B, in another embodiment of the disclosure, the order of step S220 and step S250 can be changed. That is to say, the processes related to step S250 can be performed first, and then the processes related to step S220 are performed. Details of the processes can be found in the flowchart 200B of FIG. 2B. Because the processes of FIG. 2B are similar to FIG. 2A, the details of FIG. 2B will not be discussed herein.

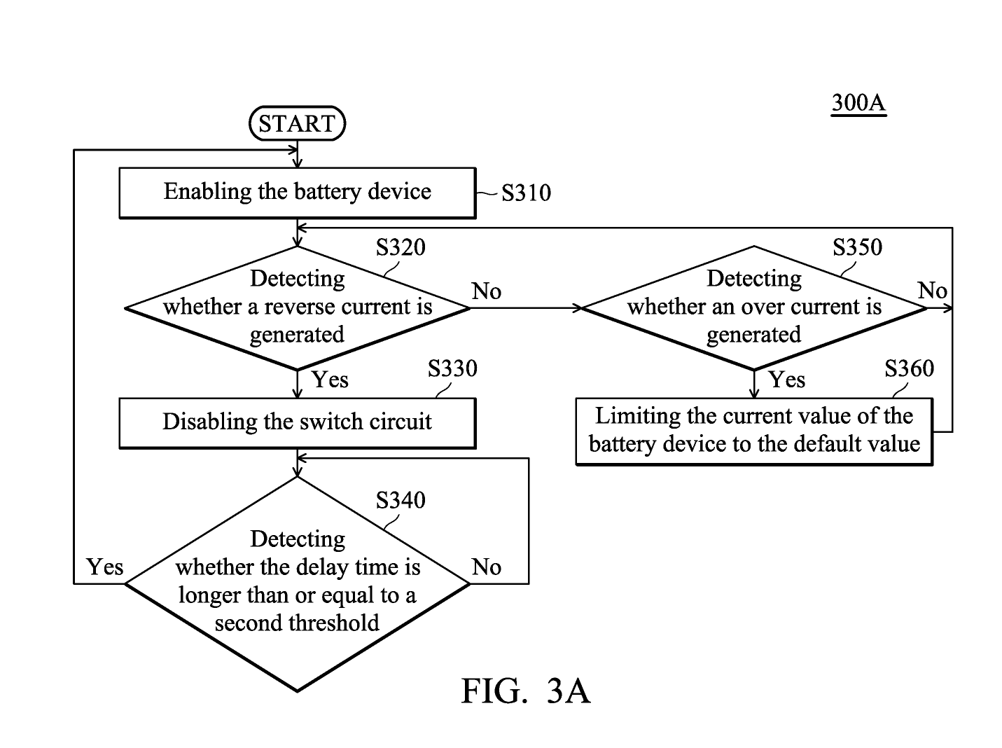

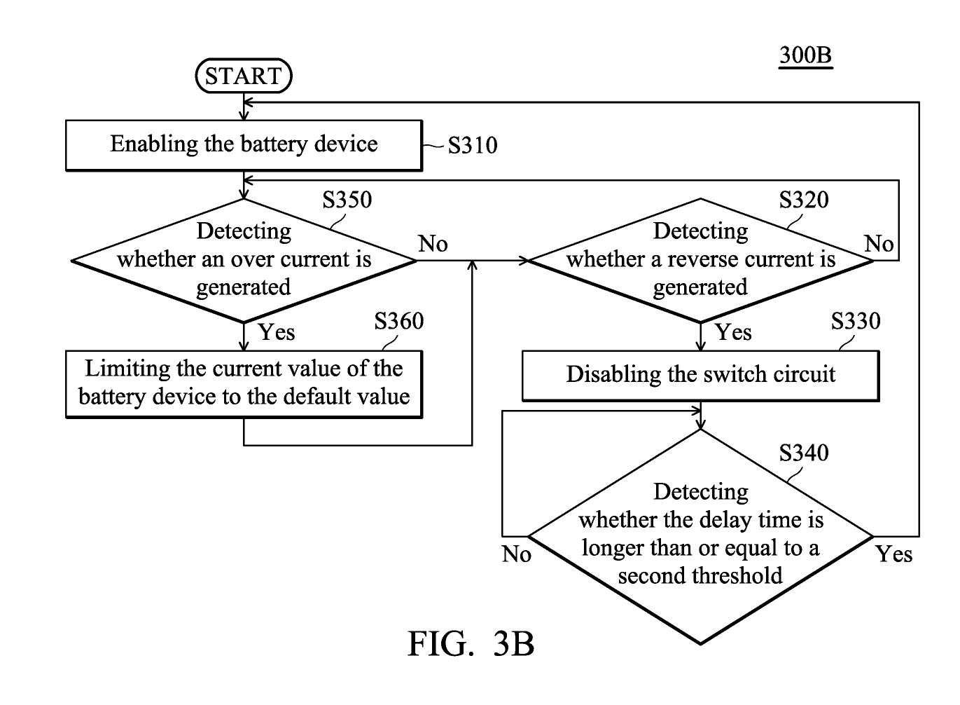

FIG. 3A is a flowchart 300A of a battery management method according to an embodiment of the disclosure. The battery management method is applied to each of the battery devices 110-1˜110-N. As shown in FIG. 3A, in step S310, the battery device is enabled. In step S320, the controller 113 detects whether a reverse current is generated. If the controller 113 detects a reverse current, step S330 will be performed. In step S330, the controller 113 disables the switch circuit 112. Then, in step S340, the controller 113 will enable a judgment mechanism to detect whether the delay time is longer than or equal to a second threshold. When the delay time is longer than or equal to the second threshold, the method returns to step S310, i.e. the controller 113 will re-enable the switch circuit 112 to enable the battery device. When the delay time is lower than the second threshold, the method returns to step S340.

If the controller 113 does not detect the reverse current, step S350 will be performed. In step S350, the controller 113 will detect whether an over current is generated. When the controller 113 detects an over current, step S360 is performed. In step S360, the controller 113 will limit the current value of the battery device to the default value. When the controller 113 does not detect an over current, the method returns to step S320.

FIG. 3B is a flowchart 300B of a battery management method according to another embodiment of the disclosure. The battery management method is applied to each of the battery devices 110-1˜110-N. As shown in FIG. 3B, in another embodiment of the disclosure, the order of step S320 and step S350 can be changed. That is to say, the processes related to step S350 can be performed first, and then the processes related to step S320 are performed. Details of the processes can be found in the flowchart 300B of FIG. 3B. Because the processes of FIG. 3B are similar to FIG. 3A, the details of FIG. 3B will not be discussed herein.

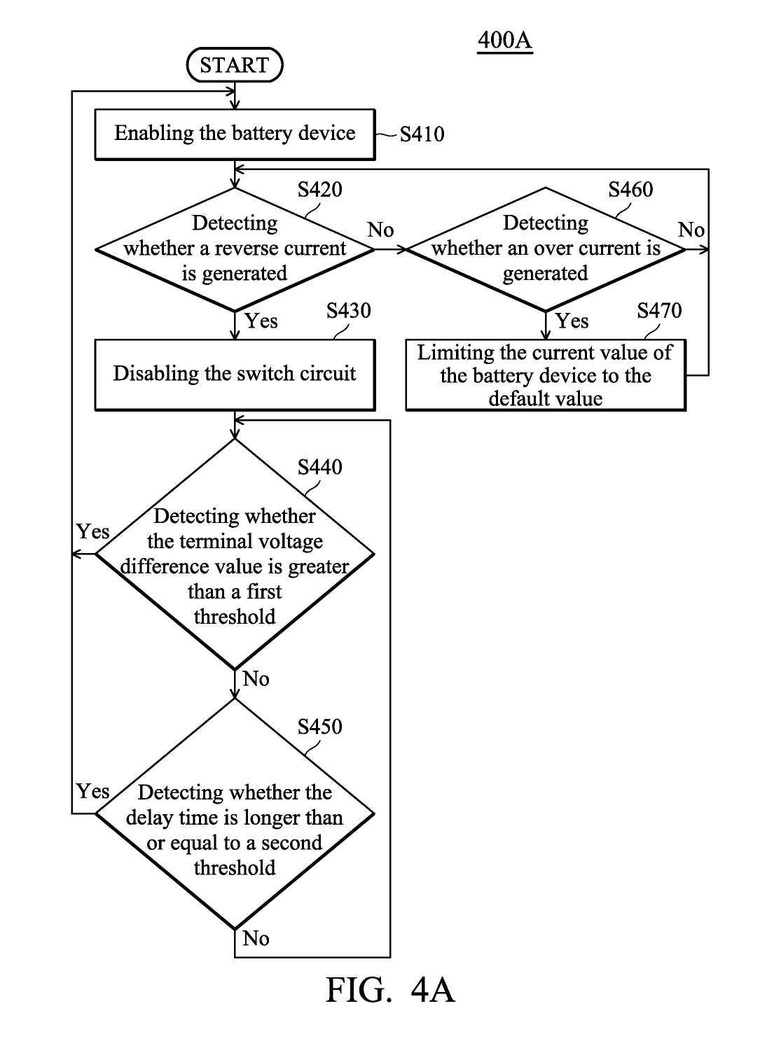

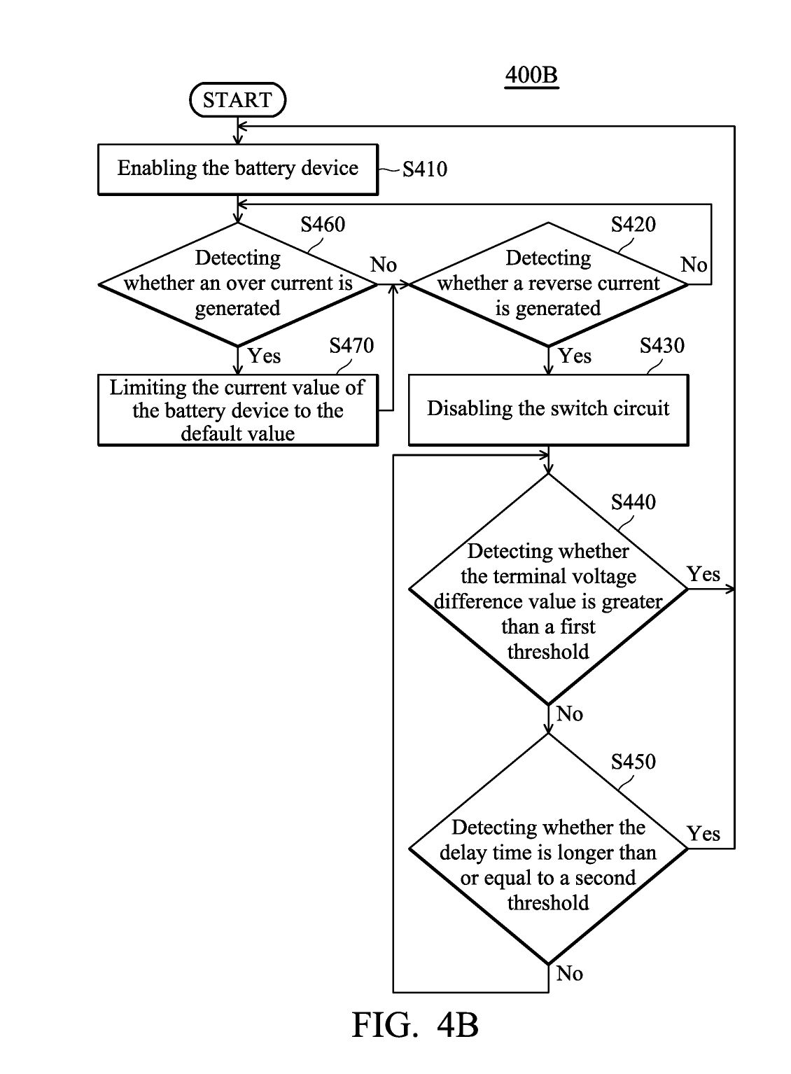

FIG. 4A is a flowchart 400A of a battery management method according to an embodiment of the disclosure. The battery management method is applied to each of the battery devices 110-1˜110-N. As shown in FIG. 4A, in step S410, the battery device is enabled. In step S420, the controller 113 detects whether a reverse current is generated. If the controller 113 detects a reverse current, step S430 will be performed. In step S430, the controller 113 disables the switch circuit 112. Then, in step S440, the controller 113 will enable a judgment mechanism to detect whether the terminal voltage difference value is greater than a first threshold. When the terminal voltage difference value is greater than the first threshold, the method returns to step S410, i.e. the controller 113 will re-enable the switch circuit 112 to enable the battery device. When the terminal voltage difference value is lower than or equal to the first threshold, step 450 will be performed. In step S450, the controller 113 further detects whether the delay time is longer than or equal to a second threshold. When the delay time is longer than or equal to the second threshold, the method returns to step S410, i.e. the controller 113 will re-enable the switch circuit 112 to enable the battery device. When the delay time is lower than the second threshold, the method returns to step S440.

If the controller 113 does not detect a reverse current, step S460 will be performed. In step S460, the controller 113 will detect whether an over current is generated. When the controller 113 detects an over current, step S470 is performed. In step S470, the controller 113 will limit the current value of the battery device to the default value. When the controller 113 does not detect an over current, the method returns to step S420.

FIG. 4B is a flowchart 400B of a battery management method according to another embodiment of the disclosure. The battery management method is applied to each of the battery devices 110-1˜110-N. As shown in FIG. 4B, in another embodiment of the disclosure, the order of step S420 and step S460 can be changed. That is to say, the processes related to step S460 can be performed first, and then the processes related to step S420 are performed. Details of the processes can be found in the flowchart 300B of FIG. 3B. Because the processes of FIG. 4B are similar to FIG. 4A, the details of FIG. 4B will not be discussed herein.

In an embodiment of the disclosure, in the management method of the above embodiments, when the battery management system 100 is in a discharged state, the terminal voltage difference value is regarded as the voltage difference value between the battery units 111 and the load 120, or it is regarded as the voltage difference value between the first voltage value and the second voltage value, wherein the first voltage value and the second voltage value are the voltage values of the load 120 at different time points.

In another embodiment of the disclosure, in the management method of the above embodiments, when the battery management system 100 is in a charged state, the terminal voltage difference value is regarded as the voltage difference value between the battery units 111 and the charging device 130, or it is regarded as the voltage difference value between the first voltage value and the second voltage value, wherein the first voltage value and the second voltage value are the voltage values of the charging device 130 at different time points.

In an embodiment of the disclosure, the management method further comprises, when the temperature of the battery device has been higher than a third threshold, a protection device will disable the switch circuit 112. In another embodiment of the disclosure, the management method further comprises, when the voltage of the battery device has been higher than a fourth threshold, a protection device will disable the switch circuit 112. In another embodiment of the disclosure, the management method further comprises, when the voltage of the battery device has been lower than a fifth threshold, a protection device will disable the switch circuit 112. In another embodiment of the disclosure, the management method further comprises, when an over current is being generated over a default time, a protection device will disable the switch circuit 112.

According to the management method of the disclosure, a simple low cost and low power consumption balance control system for battery devices which are connected in parallel can be realized, and the balance control system does not need a central control system to collect all battery information of all battery devices to control the battery devices. That is to say, each of the battery devices can determine for itself whether to enable, close, or limit the current using its judgment mechanism to achieve a charge/discharge balance of all battery devices which are connected in parallel. In addition, the management method of the disclosure can be directly applied to present battery devices without adding any elements, and it can resolve the problems of the reverse current or only single battery device provide power to load to achieve charge/discharge balance of all battery devices which are connected in parallel.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

Reference throughout this specification to “one embodiment” or “an embodiment” means that a particular feature, structure, or characteristic described in connection with the embodiment is included in at least one embodiment of the disclosure, but does not denote that they are present in every embodiment. Thus, the appearances of the phrases “in one embodiment” or “in an embodiment” in various places throughout this specification are not necessarily referring to the same embodiment of the disclosure. Furthermore, the particular features, structures, or characteristics may be combined in any suitable manner in one or more embodiments. Furthermore, the figures of the disclosure are only for illustration and are not drawn to scale.

The above paragraphs describe many aspects. Obviously, the teaching of the disclosure can be accomplished by many methods, and any specific configurations or functions in the disclosed embodiments only present a representative condition. Those who are skilled in this technology can understand that all of the disclosed aspects in the disclosure can be applied independently or be incorporated.

While the disclosure has been described by way of example and in terms of preferred embodiment, it is to be understood that the disclosure is not limited thereto. Those who are skilled in this technology can still make various alterations and modifications without departing from the scope and spirit of this disclosure. Therefore, the scope of the present disclosure shall be defined and protected by the following claims and their equivalents.

What is claimed is:

1. A battery management system, comprising:
a plurality of battery devices, wherein each of the battery devices is connected in parallel,
wherein each of the battery devices comprises:
a or a plurality of battery units, configured to provide power;
a switch circuit; and
a controller, configured to detect a reverse current, wherein when the controller detects the reverse current, the controller disables the switch circuit and enables a judgment mechanism to determine whether to re-enable the switch circuit.

2. The battery management system of claim 1, wherein the judgment mechanism comprises a step of detecting whether a terminal voltage difference value is greater than a first threshold, wherein when the terminal voltage difference value is greater than the first threshold, the controller re-enable the switch circuit.

3. The battery management system of claim 1, wherein the judgment mechanism comprises a step of detecting whether a delay time is longer than or equal to a second threshold, wherein when the delay time is longer than or equal to the second threshold, the controller re-enables the switch circuit.

4. The battery management system of claim 2, wherein when the terminal voltage difference value is smaller than or equal to the first threshold, the judgment mechanism comprises a step of detecting whether a delay time is longer than or equal to a second threshold, wherein when the delay time is longer than or equal to the second threshold, the controller re-enable the switch circuit.

5. The battery management system of claim 4, wherein when the delay time is smaller than the second threshold, the controller re-detects whether the terminal voltage difference value is greater than the first threshold.

6. The battery management system of claim 2, wherein in a discharged state, the terminal voltage difference value is a voltage difference value between the battery unit and a load.

7. The battery management system of claim 2, wherein in a discharged state, the terminal voltage difference value is a voltage difference value between a first voltage value of a load and a second voltage of the load.

8. The battery management system of claim 2, wherein in a charged state, the terminal voltage difference value is a voltage difference value of the battery unit and a charging device.

9. The battery management system of claim 2, wherein in a charged state, the terminal voltage difference value is a voltage difference value of a first voltage value of a charging device and a second voltage of the charging device.

10. The battery management system of claim 1, wherein the controller is further configured to detect an over current, and limit a current value of the battery device corresponding to the controller to a default value when the controller detected the over current.

11. The battery management system of claim 1, wherein each of the battery devices further comprises a protection device configured to disable the switch circuit when the battery device is abnormal.

12. A battery management method, applied to a battery device which is connected in parallel, the battery management method comprising:
detecting whether a reverse current is generated;
disabling a switch circuit of the battery device when the reverse current is detected; and
enabling a judgment mechanism to determine whether to re-enable the switch circuit.

13. The battery management method of claim 12, wherein the judgment mechanism comprises:
detecting whether a terminal voltage difference value is greater than a first threshold; and
re-enable the switch circuit when the terminal voltage difference value is greater than the first threshold.

14. The battery management method of claim 12, wherein the judgment mechanism comprises:
detecting whether a delay time is longer than or equal to a second threshold; and
re-enable the switch circuit when the delay time is longer than or equal to the second threshold.

15. The battery management method of claim 13, further comprising:
detecting whether a delay time is longer than or equal to a second threshold when the terminal voltage difference value is smaller than or equal to the first threshold; and
re-enable the switch circuit when the delay time is longer than or equal to the second threshold.

16. The battery management method of claim 15, further comprising:
re-detecting whether the terminal voltage difference value is greater than the first threshold when the delay time is smaller than the second threshold.

17. The battery management method of claim 13, wherein in a discharged state, the terminal voltage difference value is a voltage difference value of battery units of the battery device and a load.

18. The battery management method of claim 13, wherein in a discharged state, the terminal voltage difference value is a voltage difference value of a first voltage value of a load and a second voltage of the load.

19. The battery management method of claim 13, wherein in a charged state, the terminal voltage difference value is a voltage difference value of battery units between the battery device and a charging device.

20. The battery management method of claim 13, wherein in a charged state, the terminal voltage difference value is a voltage difference value between a first voltage value of a charging device and a second voltage of the charging device.

21. The battery management method of claim 13, further comprising:
detecting whether an over current is generated; and
limiting a current value of the battery device to a default value when the over current is detected.

22. The battery management method of claim 13, wherein the battery device further comprises a protection device configured to disable the switch circuit when the battery device is abnormal.
